(19) United States
(12) Patent Application Publication
(10) Pub. No.: US 2026/0043498 A1
(43) Pub. Date: Feb. 12, 2026

(54) FLEXIBLE LIQUID CIRCULATION PIPE WITH SPIRAL

(71) Applicants: Xavier ANDRE, EPERNAY (FR); Gaël DENNEVAULT, EPERNAY (FR)

(72) Inventors: Xavier ANDRE, EPERNAY (FR); Gaël DENNEVAULT, EPERNAY (FR)

(73) Assignee: EXEL INDUSTRIES, EPERNAY (FR)

(21) Appl. No.: 19/294,945

(22) Filed: Aug. 8, 2025

(30) Foreign Application Priority Data
Aug. 9, 2024 (FR) 2408835

(51) Int. Cl. F16L 11/08

(52) U.S. Cl. CPC F16L 11/081

(57) ABSTRACT

The present invention targets a pipe for fluid and/or solid particle circulation, flexible and of circular section, comprising a hollow tubular flexible sheath, and a rigid rod, said flexible sheath forming a cylindrical portion being made from a soft polymer material comprising a foam, said rigid rod being characterized by a diameter equal to at least 70% of the thickness of the soft polymer material of the flexible sheath and being wound in a spiral at least partially integrated into the flexible sheath to form a spiral extending along the pipe.

### TECHNICAL FIELD

The present invention relates to the field of pipes and conduits and more specifically to a pipe for the circulation of fluids, notably water, and/or solids, notably granules. The invention particularly targets a rigid spiral pipe.

### BACKGROUND

Pipes are devices widely used in different applications, notably for the circulation of liquids and solids. Water is one of the fluids that can be transported by such pipes. Solids can be granules, notably seeds or powders.

The applications wherein pipes are used to transport fluids and solids are numerous, ranging from industrial applications to domestic applications, such as feeding an agricultural machine or suctioning wastewater.

In these applications, important properties of the pipes used are their mass, robustness, and flexibility.

The robustness of such pipes, in other words their mechanical strength, is indeed necessary, notably to allow the transport of fluids and granules under pressure or vacuum (in other words when fluids or granules are suctioned), to slow down their wear and reduce the risks of deformation during their use. A pipe that is not sufficiently robust can indeed become fragile, resulting in sagging or rupture of the pipe.

Flexibility allows the pipe to adapt to different configurations wherein a user may want to use it, indoors or outdoors, and also allows for easier use.

These two properties can be antagonistic, given that robustness can make the pipe less flexible, and flexibility can make the pipe more fragile, thus more likely to puncture.

A known solution is to make the pipe from a textile thickness sandwiched between at least two layers of polymer material. This widely used solution does not allow the production of pipes with an internal diameter greater than 50 mm. Moreover, such pipes do not resist vacuum and collapse when a strong vacuum is applied.

Another known solution is to use a rigid spiral pipe, wherein a rigid or semi-rigid rod is embedded and wound in a spiral in a soft polymer matrix to form the outer polymer sheath of the pipe. This design allows for vacuum resistance and the manufacture of robust pipes with an internal diameter greater than 50 mm. However, the flexibility of such pipes is generally limited.

Thus, given the desired length and section for certain pipes, depending on the intended applications, it remains necessary to improve the compromise between mechanical strength and flexibility.

There is therefore a need for a simple and effective solution to improve these properties of fluid and/or solid particle circulation pipes.

### SUMMARY

More precisely, the invention relates to a fluid and/or solid particle circulation pipe, flexible and of circular section, comprising a hollow tubular flexible sheath and a rigid rod, said flexible sheath forming a cylindrical portion being made from a soft polymer material comprising a foam, said rigid rod being characterized by a diameter equal to at least 70% of the thickness of the soft polymer material comprising a foam of the flexible sheath and being wound in a spiral at least partially integrated into the flexible sheath to form a spiral extending along the pipe.

The pipe according to the invention is thus resistant due to the presence of the spiral while remaining flexible and having a low linear mass. The force required to bend the pipe with low linear mass is less than that required to bend the heavier pipe while maintaining identical mechanical characteristics.

Preferably, the internal diameter of the flexible sheath is between 12 millimeters and 500 millimeters. The internal diameter corresponds to the nominal diameter (DN).

In one embodiment, the rigid rod is characterized by a diameter equal to at least 100% of the thickness of the soft polymer material comprising a foam of the flexible sheath and notably at most equal to 150% of the thickness of the flexible sheath.

Advantageously, the flexible sheath is composed of a soft polymer material whose Shore hardness before foam formation is between 50 ShA and 90 ShA.

Advantageously, in this embodiment, the soft part is made from polyvinyl chloride (PVC). PVC thus allows the desired Shore hardness to be achieved while having interesting impermeability and flexibility properties for pipe applications.

Preferably, the foam of the flexible sheath comprises at least one mineral or organic filler. For example, the type of filler in the foam of the flexible sheath can be titanium dioxide (TiO2), barium sulfate (BaSO4), calcium carbonate (CaCO3), mica, glass microbeads, etc. These fillers help improve certain properties of the pipe, depending on the intended final application.

Advantageously, the foam of the flexible sheath has a density corresponding to 90% or less of the density of the soft polymer material of the flexible sheath before foam formation. The foam thus makes it possible, for a given final volume of the sheath, to have a reduced mass of polymer material, which ensures the lightness of the pipe according to the invention.

Preferably, the foam of the flexible sheath is formed by gas injection, for example, carbon dioxide or nitrogen gas, or by thermal activation of an expansion agent releasing a gas allowing the formation of the foam, said expansion agent being advantageously incorporated into the composition of the soft polymer material of the flexible sheath.

In one embodiment, the rigid rod is made of a material with a Shore hardness between 50 ShD and 90 ShD.

Preferably in this embodiment, the rigid rod is made of a thermoplastic material, which ensures the hardness of the rigid rod while being easy to shape.

Advantageously, the rigid rod is made from polyvinyl chloride.

Preferably, the rigid rod comprises up to 40% by mass of mineral or organic filler, preferably up to 20% by mass, which ensures the hardness of the rod as well as the mechanical properties of the rod necessary for the final application of the pipe.

Alternatively, the rigid rod can be made of a metallic material, such as iron, steel, stainless steel, copper, aluminum, with or without surface treatment.

### BRIEF PRESENTATION OF THE DRAWINGS

The invention will be better understood by reading the following description, given solely as an example, and referring to the attached drawings given as non-limiting examples, wherein identical references are given to similar objects and on which:

FIG. 1 is a schematic representation of a pipe according to the invention;

FIG. 2 is a schematic representation of a longitudinal sectional view of the pipe according to the invention, in an embodiment where the diameter of the rigid rod is less than the thickness of the flexible sheath;

FIG. 3 is a schematic representation of a longitudinal sectional view of the pipe according to the invention, in an embodiment where the diameter of the rigid rod is greater than the thickness of the flexible sheath and wherein the rigid rod is covered by the flexible sheath;

FIG. 4 is a graph representing the bending radius of a pipe resulting from a defined force, for a state-of-the-art pipe on the one hand and for a pipe according to the invention on the other hand;

FIG. 5 is a schematic representation of a longitudinal sectional view of the pipe according to the invention, in an embodiment where the diameter of the rigid rod is greater than the thickness of the flexible sheath and for which the rigid rod is not entirely covered by the flexible sheath.

It should be noted that the figures present the invention in detail to enable the implementation of the invention; although not limiting, these figures serve notably to better define the invention if necessary.

### DETAILED DESCRIPTION

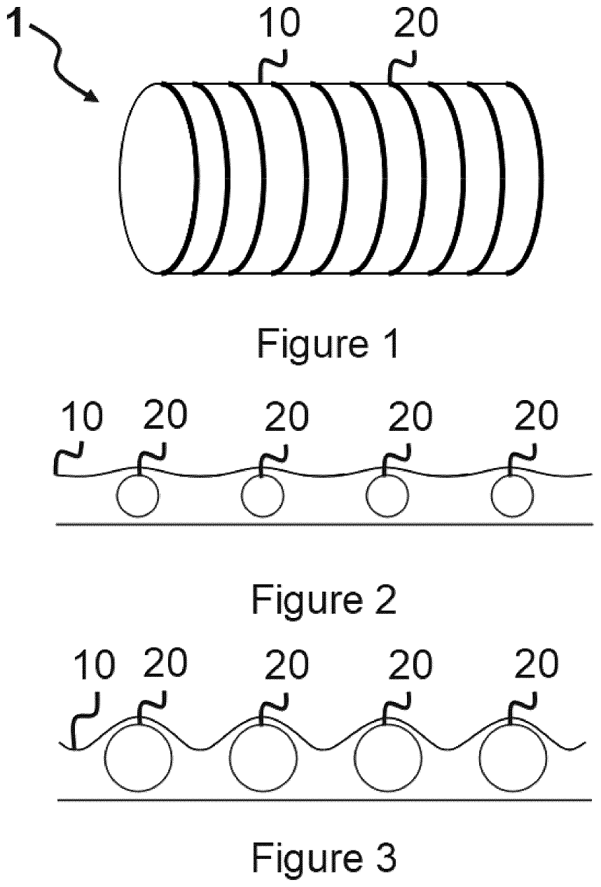

The invention relates to a pipe 1 as shown in FIG. 1.

### Pipe 1

As shown in FIG. 1, the pipe 1 comprises a flexible sheath 10 and a rigid rod 20.

In the embodiments shown in the figures, the rigid rod 20 is comprised inside the flexible sheath 10.

The pipe 1 has a hollow tube shape, characterized by an internal diameter and an external diameter.

The internal diameter, also called nominal diameter (DN), is the reference diameter for calculating the flow rate of fluid and/or solid particles, notably water, in the pipe 1, during its use.

In a preferred embodiment, the internal diameter of the pipe 1 is between 12 millimeters and 500 millimeters, which corresponds respectively to a DN 12 and a DN 500.

### Flexible Sheath 10

The flexible sheath 10 of the pipe 1 allows the circulation of fluid and/or solid particles, particularly without leaks.

The flexible sheath 10 is made from a foam of polymer material wherein an expansion agent has been incorporated, or wherein gas has been injected during extrusion.

In the embodiment wherein the foam contains an expansion agent, this expansion agent is preferably thermally activated. In this case, the expansion agent releases a gas allowing the formation of the foam.

The polymer material is preferably polyvinyl chloride, more commonly known as PVC. For the composition of the flexible sheath, PVC is flexible and has a Shore hardness between 50 ShA and 90 ShA before foam formation.

The foam of polymer material also comprises one or more types of mineral or organic fillers depending on the intended applications. For example, the fillers can be titanium dioxide (TiO2), barium sulfate (BaSO4), calcium carbonate (CaCO3), talc, mica, glass microbeads. According to a first preferred embodiment, the filler used is calcium carbonate. According to a second preferred embodiment, the filler used is titanium dioxide. Such fillers enable to obtain a mixture corresponding to the loaded polymer material foam, which is homogeneous and has high cohesion.

Notably, the percentage of filler added in the polymer material foam can reach 40% by mass. It is preferably less than or equal to 20% by mass.

Preferably, the foam is composed of the soft polymer material and of bubbles formed by the release of nitrogen or carbon dioxide.

As previously indicated, the foam of the flexible sheath 10 can be formed by thermal activation of an expansion agent releasing a gas allowing the formation of the foam.

The foam of the flexible sheath 10 can thus have a density corresponding to 90% or less of the density of the soft polymer material of the flexible sheath 10 before foam formation.

### Rigid rod 20

As shown in FIGS. 2 and 3, the rigid rod 20 is wound in and around the flexible sheath 10 to form a spiral.

The spiral thus formed is entirely or partially comprised in the flexible sheath 10.

The diameter of the rigid rod 20 is at least equal to 70% of the thickness of the flexible sheath 10, particularly greater than or equal to 100% of the thickness of the flexible sheath 10. Notably, the diameter of the rigid rod 20 is also less than or equal to 150% of the thickness of the flexible sheath 10.

In the case where the diameter of the rigid rod 20 is less than the thickness of the flexible sheath 10, the rigid rod 20 is completely comprised in the flexible sheath 10, as shown in FIG. 2.

In the case where the diameter of the rigid rod 20 is greater than the thickness of the flexible sheath 10, the rigid rod 20 creates protrusions in the flexible sheath 10, as shown in FIG. 3. These protrusions can be covered, as shown in FIG. 3, or not, as shown in FIG. 5, by the flexible sheath 10.

In a first embodiment, the rigid rod 20 is made from a thermoplastic polymer material, such as PVC.

In a second embodiment, the rigid rod is made of a metallic material, such as galvanized steel.

Advantageously, the rigid rod 20 is made of PVC more rigid than that used in the composition of the flexible sheath 10. Preferably, the Shore hardness of the rigid rod 20 is between 50 ShD and 90 ShD.

To obtain the desired properties of the rigid rod 20, notably its hardness, mineral or organic fillers are added to the PVC, for example, calcium carbonate (CaCO3), mica, ethylene-propylene-diene monomer (EPDM) rubbers, plant-based fillers, etc.

Notably, the percentage of filler is less than or equal to 40%; it is preferably less than or equal to 20%.

Preferably, the mass of the rigid rod 20 represents 20 to 65% of the total mass of the pipe 1, preferably between 40 and 60%.

The pipe 1 thus composed can have a linear mass of 100 g/m to 20,000 g/m, depending on the nominal diameter of the pipe, for a density of 0.9 (±0.1), which represents a 25% gain compared to existing pipes, with equivalent characteristics and performances elsewhere, particularly, for equivalent internal diameters of the pipe and liquid pressures circulating in the pipes.

In addition to the diameter, by “equivalent characteristics and performances,” we mean in particular the service pressure, the burst pressure, and the vacuum resistance of the pipe.

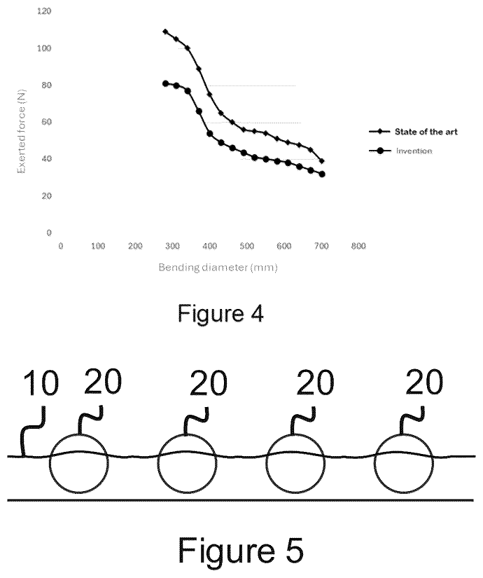

As shown in FIG. 4, the pipe 1 according to the invention has better flexibility than state-of-the-art pipes, since for an equal applied force, the bending radius obtained with the pipe 1 is smaller; in other words the pipe is more manageable and rollable without breaking.

It should also be noted that the invention is not limited to the embodiments described above. It will indeed appear to those skilled in the art that various modifications can be made to the embodiments described above, in light of the teaching that has just been disclosed to them.

In the detailed presentation of the invention made above, the terms used should not be interpreted as limiting the invention to the embodiment presented in this description, but should be interpreted to comprise all equivalents whose prediction is within the reach of those skilled in the art by applying their general knowledge to the implementation of the teaching that has just been disclosed to them.

1. A pipe for fluid and/or solid particle circulation, flexible and of circular section, comprising a hollow tubular flexible sheath, and a rigid rod, said flexible sheath forming a cylindrical portion comprising a foam obtained from a polymer material, wherein said rigid rod has a diameter equal to at least 100% of the thickness of the soft polymer material comprising a foam of the flexible sheath and at most equal to 150% of said thickness, said rigid rod being wound in a spiral at least partially integrated into the flexible sheath to form a spiral extending along the pipe.

2. The pipe according to claim 1, wherein the internal diameter of the flexible sheath is comprised between 12 millimeters and 500 millimeters.

3. The pipe according to claim 1, wherein the soft polymer material before formation of the foam of the flexible sheath has a Shore hardness of between 50 ShA and 90 ShA.

4. The pipe according to claim 1, wherein the foam of the flexible sheath has a density corresponding to 90% or less of the density of the soft polymer material before formation of the foam.

5. The pipe according to claim 1, wherein the foam of the flexible sheath is obtained by gas injection into the soft polymer material, such as carbon dioxide or nitrogen gas, or formed by thermal activation of an expansion agent releasing a gas in the soft polymer material allowing the formation of the foam.

6. The pipe according to claim 1, wherein the rigid rod is made of a thermoplastic polymer material.

7. The pipe according to claim 6, wherein the rigid rod comprises up to 40% by mass of mineral or organic filler.

8. The pipe according to claim 6, wherein the rigid rod comprises up to 20% by mass of mineral or organic filler.

9. The pipe according to a claim 1, wherein the rigid rod has a Shore hardness between 50 ShD and 90 ShD.

10. The pipe according to claim 1, wherein the rigid rod is made of a metallic material.
